(19) United States
(12) Patent Application Publication
(10) Pub. No.: US 2005/0253803 A1
(43) Pub. Date: Nov. 17, 2005

(54) Electric paper display with a thin film transistor active matrix and integrated addressing logic

(75) Inventors: Malcolm Thompson, Mountain View, CA (US); Russel Martin, Menlo Park, CA (US)

Correspondence Address: PILLSBURY WINTHROP SHAW PITTMAN, LLP, P.O. BOX 10500, MCLEAN, VA, 22102, US

(73) Assignee: Xerox Corporation

(21) Appl. No.: 11/001,925

(22) Filed: Dec. 2, 2004

Related U.S. Application Data
(60) Provisional application No. 60/570,938, filed on May 13, 2004.

(51) Int. Cl. G09G 3/34

(52) U.S. Cl. 345/107

(57) ABSTRACT

An electric display is described including a plurality of rotatable elements, a thin film transistor active matrix array containing a plurality of thin film transistors which are arranged as one or more rows and one or more columns of transistors, each transistor having a gate input and a data input, which inputs are coupled to a gate control logic and a data control logic, respectively.

This application claims benefit of, under 35 U.S.C. §119(e), U.S. Provisional Application Ser. No. 60/570,938, filed May 13, 2004.

### BACKGROUND

Disclosed is an electric visual display. More particularly, an electric paper display using a thin film transistor active matrix array and integrated addressing logic to control the output of the display is disclosed useful, for example, as point of purchase signs.

Traditional signs have been based upon printed materials, paper, plastic, metal, etc., and are, therefore, not programmable. Accordingly, they are not easily changed. In an attempt to overcome this problem, electronically programmable and/or controllable signs have been in existence for many years. For example, liquid crystal diode (LCD) displays, cathode ray tube (CRT) displays, and other electrically-addressable displays will display an image in response to applied electric signals or fields. However, such signs typically require a large amount of electricity, since they must provide illumination in order to be visible to a viewer.

Electric writeable media, including twisting-cylinder and rotary ball displays, such as those described in U.S. Pat. Nos. 4,126,854 and 4,143,103 to Sheridon, incorporated herein by reference in their entirety, have been developed to overcome the problems with previous programmable signs. Twisting-cylinder displays, rotary-ball displays and related displays have numerous advantages over conventional displays, such as LCDs and CRTs, since they are suitable for viewing in ambient light, they retain an image indefinitely in the absence of an applied electric field, and they can be made to be very lightweight and/or flexible. For further advantages of such displays, see U.S. Pat. No. 5,389,945 to Sheridon, incorporated herein by reference in its entirety. Such displays are referred to herein as “electric paper” displays. An example of such a display is a SmartPaper™ display from Gyricon LLC.

Another type of electric writeable media is known as an electronic ink display, such as the one described in U.S. Pat. No. 6,518,949 to Drzaic, which is incorporated herein by reference. An electronic ink display includes at least one capsule filled with a plurality of particles, made of a material such as titania, and a dyed suspending fluid. When a direct-current electric field of an appropriate polarity is applied across the capsule, the particles move to a viewed surface of the display and scatter light. When the applied electric field is reversed, the particles move to the rear surface of the display and the viewed surface of the display then appears dark.

Yet another type of electric writeable media, also described in U.S. Pat. No. 6,518,949 to Drzaic, includes a first set of particles and a second set of particles in a capsule. The first set of particles and the second set of particles have contrasting optical properties, such as contrasting colors, and can have, for example, differing electrophoretic properties. The capsule also contains a substantially clear fluid. The capsule has electrodes disposed adjacent to it connected to a voltage source, which may provide an alternating-current field or a direct-current field to the capsule. Upon application of an electric field across the electrodes, the first set of particles moves toward a first electrode, while the second set of particles moves toward a second electrode. If the electric field is reversed, the first set of particles moves toward the second electrode and the second set of particles moves toward the first electrode. Other examples of writeable media include liquid crystal diode displays, encapsulated electrophoretic displays, and other displays.

Electric paper displays respond slowly to changes in applied voltage. However, electric paper displays are also generally addressed infrequently. Recent developments in electric paper displays are permitting operation at voltage thresholds of approximately 40V. Current electric displays are driven with crystal silicon integrated circuits in separate packages. Such integrated circuits are costly and increase the size of the display. As a result, new technologies for supplying threshold voltages are being explored.

A thin film transistor (TFT) active matrix array is composed of an array of TFTs. A TFT is a Metal-Oxide-Semiconductor Field Effect Transistor (MOSFET) implemented using thin film technology. A TFT uses thin films, which may be made of for example, amorphous silicon (a-Si), polycrystalline silicon (p-Si), or which may be an organic material, and a glass substrate. Current flows between the source and drain of a TFT when a voltage is applied to its gate. Thus, by connecting the gate of a TFT to the power rail of the TFT active matrix array, a TFT is turned on (at a positive voltage). If the gate of a TFT is connected to the ground rail, the TFT is turned off (at zero voltage).

Active matrix liquid crystal displays are a well-established technology. The gate voltage swing is typically from −10 V to +15 V, and the data voltage swing is typically ±10V. However, the transistors are capable of withstanding substantially greater voltages. For example, it is reasonable to expect that a transistor with a gate nitride thickness of 300 nm will have a breakdown voltage of more than 50V. Moreover, threshold voltage shifts that are induced by a high gate voltage are insignificant if the transistor is not turned on for a large percentage of time.

Addressing logic has previously been constructed for active matrix liquid crystal display arrays. However, such designs require logic to compensate for threshold drifts of critical transistors.

A need exists for methods and systems of controlling a display that use electric paper and thin film transistor active matrix technologies to provide low power operation and/or pixel-addressability without the need for additional logic to compensate for transistor threshold drifts.

### SUMMARY

Aspects disclosed herein include
an electric display, comprising a plurality of rotatable elements;
a thin film transistor active matrix array comprising a plurality of thin film transistors arranged as one or more rows and one or more columns, wherein each thin film transistor has a gate input and a data input;
gate control logic coupled to the gate inputs of the thin film transistors; and
data control logic coupled to the data inputs of the plurality of transistors, and
an electric display, comprising a plurality of multichromal media;
a thin film transistor active matrix array comprising a plurality of thin film transistors arranged as one or more rows and one or more columns, wherein each thin film transistor has a gate input and a data input;
gate control logic coupled to the gate inputs of the thin film transistors; and
data control logic coupled to the data inputs of the thin film transistors.

### BRIEF DESCRIPTION OF THE DRAWINGS

FIG. 1 depicts a block diagram of an exemplary control circuitry for an electric paper display.

FIG. 2 depicts a block diagram of an exemplary gate driver logic.

FIG. 3 depicts a block diagram of an exemplary data control logic.

### DETAILED DESCRIPTION OF THE INVENTION

In embodiments there is illustrated:
an electric paper display for use, for example, as a point of purchase sign, comprising a thin film transistor active matrix array and an integrated addressing logic to control the output of the display. In an embodiment, an electric paper display includes a plurality of rotatable elements, a thin film transistor active matrix array which includes a plurality of thin film transistors, gate control logic coupled to the gate inputs of the plurality of transistors, and data control logic coupled to the data inputs of the thin film transistors. The thin film transistors may be arranged as one or more rows and one or more columns of film transistors, for example, at least one row and at least one column of transistors. Furthermore, each transistor may have a gate input and a data input. In an embodiment, the gate control logic includes a shift register and one or more output buffers. Each of the output buffers may be coupled to the shift register. In an embodiment, the data control logic includes a shift register, one or more latches and one or more output buffers. Each of the latches may be coupled to the shift register. Each of the output buffers may be coupled to one of the latches.

In an embodiment, an electric display includes a plurality of multichromal media, a thin film transistor active matrix array including a plurality of thin film transistors each having a gate input and a data input, gate control logic coupled to the gate inputs of the thin film transistors, and data control logic coupled to the data inputs of the plurality of transistors. The plurality of thin film transistors may be arranged as one or more rows and one or more columns of thin film transistors, for example, at least one row and at least one column of thin film transistors. In an embodiment, the gate control logic includes a shift register and one or more output buffers. Each output buffer may be coupled to the shift register. In an embodiment, the data control logic includes a shift register, one or more latches coupled to the shift register, and one or more output buffers. Each output buffer may be coupled to one of the latches.

In an embodiment, the electric paper display using a thin film transistor (TFT) active matrix and an integrated addressing logic to control the output of the display is provided, in which a TFT active matrix array is similar to a dynamic random access memory (DRAM) array. In other words, each pixel may be at the intersection of horizontal and vertical address lines and may be addressed by enabling both lines. In one embodiment, when using TFT active matrix arrays with electric paper displays, a localized electric field used to rotate one or more rotatable elements within an electric paper display may be generated from each TFT. A rotatable element may be an anisotropic particle such as, for example, a ball, a cylinder or other particulate matter. The rotatable element may rotate when an electric field is applied across the element while the element is suspended in an electrophoretic substance. As such, an individual TFT may be used as an active switch for each picture element or pixel. Alternatively, multiple TFTs may be used to form a pixel where a first TFT controls rotatable elements of a first color, such as red, a second TFT controls rotatable elements of a second color, such as blue, and a third TFT controls rotatable elements of a third color, such as green. Each sub-pixel TFT may control one or more rotatable elements.

In an alternative embodiment, other multichromal media may be used in place of or in addition to the rotatable elements described above. Such multichromal media may include inks, dyes, pigments, pigment dispersions, dye solutions, multichromal rotatable elements, and other media that can display two or more colors depending on their orientation with respect to a viewer. Furthermore, multichromal media may include any combination of the above-listed exemplary substances or elements.

In the application of electric paper to point of purchase signs, the circuitry to control the sign may only be empowered for a very small portion of the day. For example, if a point of purchase sign were updated once a day, the sign may only be powered for about two minutes per day, or for about 0.14% of the time. If a threshold shift were to occur in a TFT during this time because a voltage surpassing the TFT gate breakdown voltage is supplied to the TFT, the TFT would return to its original state during the time that the circuit is not powered. As a result, control circuitry for a TFT active matrix array used in an electric paper display may be simplified by not accounting for voltage levels greater than the TFT gate breakdown voltage.

Generally, TFT active matrix arrays may be limited by the speed with which they may be updated. Since liquid crystal displays are generally refreshed at 60 Hz, the low mobility of the TFT active matrix array may be unable to provide a complete refresh to a liquid crystal display with a refresh cycle. In addition, as the size of the display increases, the load capacitance and, therefore, the transistor power up time increases as well. In contrast, the addressing speed required for electric paper displays is much slower than for an active matrix liquid crystal display. As a result a TFT active matrix array may be used in an electric paper display to perform the addressing logic of the pixel elements.

In addition, the control circuitry of an electric paper display would differ from active matrix liquid crystal displays in that the gate and data lines would each require only a two-level output. Although the addressing logic for gate lines in an electric paper display and in a liquid crystal display may be similar, the data lines in a liquid crystal display utilizes a range of output voltages to provide the grayscale capability of an LCD. In contrast, in electric paper displays the data lines may require only two states: on or off. In this embodiment, the circuitry may be vastly simplified.

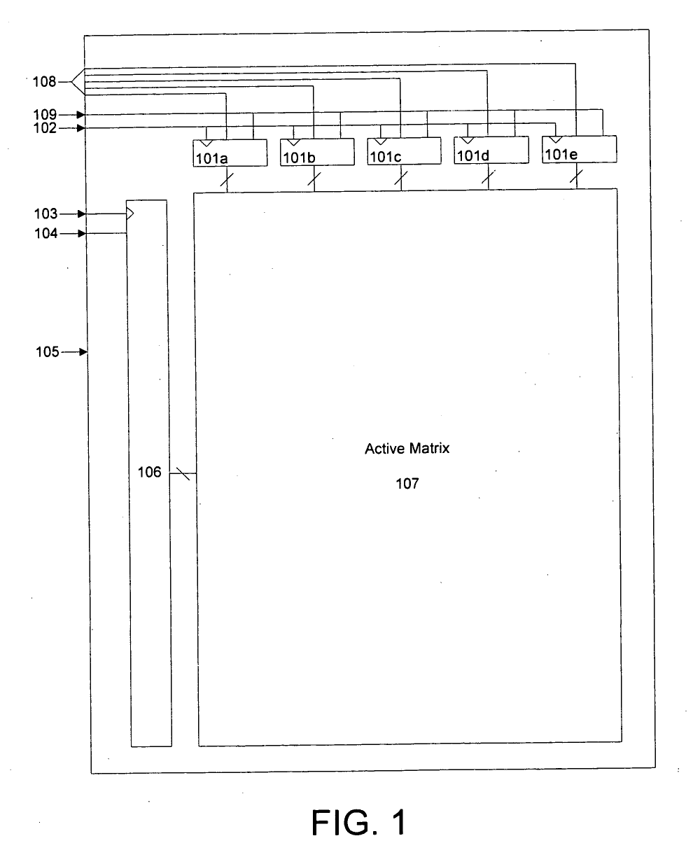

FIG. 1 illustrates a block diagram of a control circuitry for an electric paper display according to an embodiment. The electric paper display 105 includes one or more data drivers, such as the five data drivers shown in FIG. 1 at 101a, 101b, 101c, 101d and 101e; a gate driver 106 and an active matrix array 107. Each data driver 101a-101e may include a data input 108, a shared data clock 102 and a data enable 109, for latching the data input to the output of the data driver. The gate driver 106 may include a gate input 104 and a gate clock 103. The gate driver 106 may have one output for each row of the active matrix array 107.

Alternate embodiments may include different numbers of data drivers 101 ad/or gate drivers 106. In addition, different voltage levels may be used for the one or more gate drivers. For instance, where a color electric paper display is used, one or more gate drivers may be used for each color used for a pixel. The gate drivers for each sub-pixel color may be driven at different voltage levels so that only the rotatable elements corresponding to an appropriate color are updated at a given time.

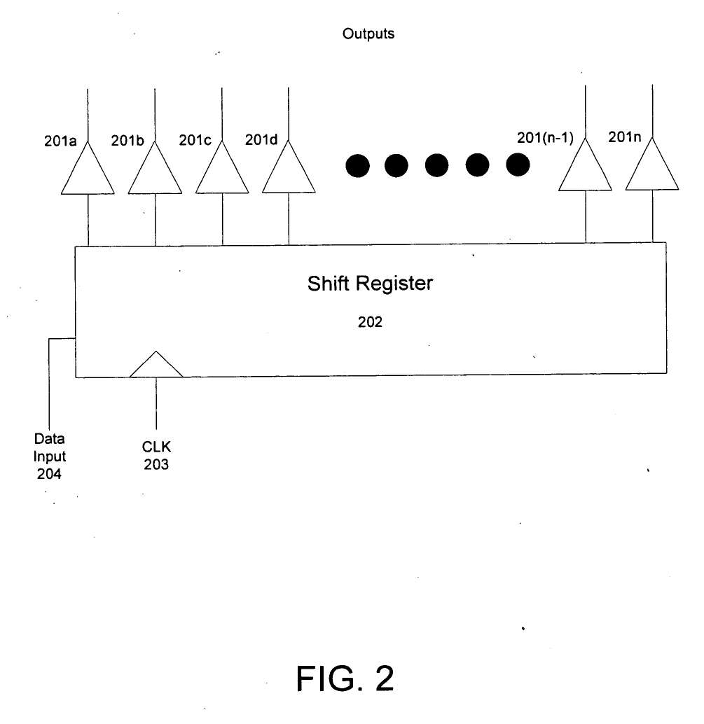

FIG. 2 illustrates an embodiment depicting a block diagram of a gate driver logic. A gate driver, such as 106 in FIG. 1 may include a shift register 202 and one or more output buffers 201a through 201n. One output buffer 201 may be used for each row of the active matrix array 107 controlled byte gate driver such as gate driver 106 referenced in FIG. 1. The shift register 202 has a data input 204 and a clock input 203, each of which may operate at any conventional voltage level, such as 5V or 3.3V. The output data buffers 201 may amplify the output of the shift register 202. As a result the power consumed by the circuit may be reduced because the shift register 202 does not operate at the higher voltage level required to drive the gates of the TFTs in the active matrix array 107. This may occur because the shift register 202 encompasses the majority of the circuitry for controlling the gate driver logic.

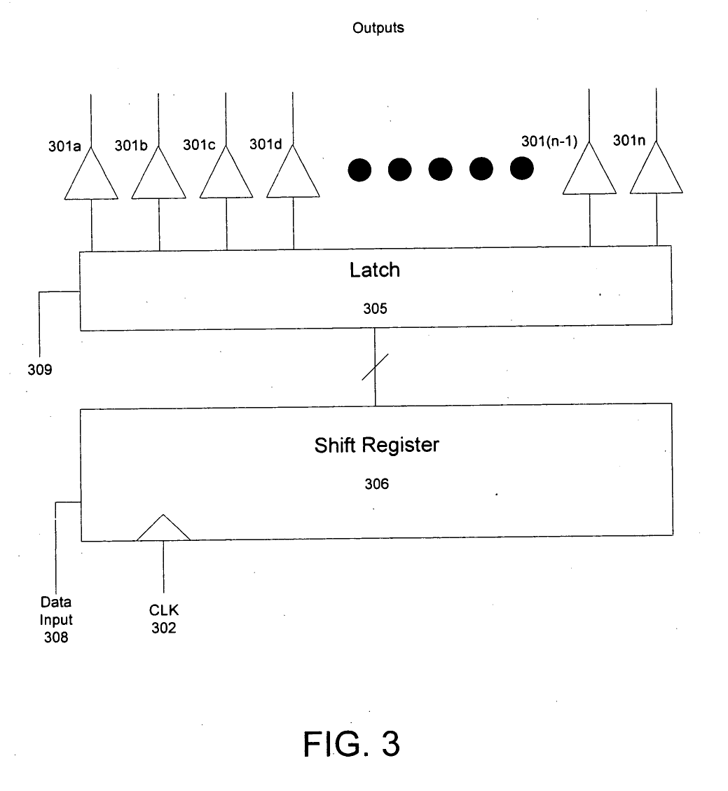

FIG. 3 illustrates an embodiment depicting a block diagram of the data control logic. The data control logic may include a shift register 306, a latch 305, and an output buffer 301 for each column of the active matrix array 107 illustrated in FIG. 1. The shift register 306 has a data input 308 and a clock input 302, each of which may operate at any conventional voltage level, such as 5V or 3.3V. In operation, data may be loaded one row at a time into the shift register 306. When a complete row has been enabled, a data enable line 309 may be used to permit the data in the shift register 306 to be passed through the latch 305 to the output buffers 301. The output data buffers 301 may amplify the output of the latch 305. The power consumed byte data control logic may thus be reduced in a manner consistent with the power consumption reduction of the gate control logic described above in reference to FIG. 2.

In an alternate embodiment, more than one shift registers may replace the shift register 306 of FIG. 3. By using multiple shift registers, the data lines may be more rapidly loaded with information. Such a design may be used where the refresh cycle of the display is shorter than the write cycle of the active matrix array 107 of FIG. 1 where only a single shift register is used for the data lines. In addition, for large displays, multiple shift registers may be used to enable rapid display updates. In addition, more than one latches may be used to replace the single latch 305 of FIG. 3 where the width of a single latch is less than the number of columns in the active matrix array 107 illustrated in FIG. 1.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An electric display, comprising:
a plurality of rotatable elements;
a thin film transistor active matrix array comprising a plurality of thin film transistors arranged as one or more rows and one or more columns, wherein each thin film transistor has a gate input and a data input;
a gate control logic coupled to the gate inputs of the thin film transistors; and
a data control logic coupled to the data inputs of the thin film transistors.

2. The electric display in accordance with claim 1, wherein the gate control logic comprises:
a shift register; and
one or more output buffers, wherein each output buffer is coupled to the shift register.

3. The electric display in accordance with claim 1, wherein the data control logic comprises:
a shift register;
one or more latches coupled to the shift register; and
one or more output buffers, wherein each output buffer is coupled to one of the latches.

4. The electric display in accordance with claim 1, wherein the rotatable elements is an anisotropic particle selected from a ball or a cylinder.

5. The electric display in accordance with claim 1, wherein the rotatable elements rotate when an electric field is applied across the rotatable elements while the elements are suspended in an electrophoretic substance.

6. The electric display in accordance with claim 1, wherein a first thin film transistor controls rotatable elements of a first color, a second thin film transistor controls rotatable elements of a second color and a third thin film transistor controls rotatable elements of a third color.

7. The electric display in accordance with claim 1, wherein the electric display is an electric paper.

8. The electric display in accordance with claim 1, wherein the display is a point of purchase sign.

9. The electric display in accordance with claim 1, wherein the thin film transistors comprises amorphous silicon or polycrystaline silicone, or combinations thereof.

10. An electric display, comprising:
a plurality of multichromal media;
a thin film transistor active matrix array comprising a plurality of thin film transistors, wherein the plurality of thin film transistors are arranged as at least one row and at I east one column of transistors, wherein each transistor has a gate input and a data input;
a gate control logic coupled to the gate inputs of the plurality of transistors; and
a data control logic coupled to the data inputs of the plurality of transistors.

11. The electric display in accordance with claim 10, wherein the gate control logic comprises:
a shift register; and
one or more output buffers, wherein each output buffer is coupled to the shift register.

12. The electric display in accordance with claim 10, wherein the data control logic comprises:
a shift register;
one or more latches, coupled to the shift register; and
one or more output buffers, wherein each output buffer is coupled to one of the latches.

13. The electric display in accordance with claim 10, wherein the multichromal media comprises inks, dyes, pigments, pigment dispersions, dye solutions, multichromal rotatable elements or combinations thereof.

14. The electric display in accordance with claim 10, wherein the multichromal media displays two or more colors.
